(19) United States
(12) Patent Application Publication
(10) Pub. No.: US 2026/0225093 A1
(43) Pub. Date: Aug. 6, 2026

(54) CONTAINER DOOR FOR SEALED TRANSFER SYSTEM

(71) Applicant: GETINGE LIFE SCIENCE FRANCE SAS, Vendôme (FR)

(72) Inventor: Jean BELIN, LUNAY (FR)

(21) Appl. No.: 19/149,766

(22) PCT Filed: Jan. 24, 2024
(86) PCT No.: PCT/EP2024/051669

§ 371 Date: Jul. 21, 2025

(30) Foreign Application Priority Data
Jan. 25, 2023 (FR) FR2300669

(51) Int. Cl. B01L 1/02

(52) U.S. Cl. CPC B01L 1/02; B01L 2300/043

(57) ABSTRACT

Container door comprising a cylindrical body along a main axis of revolution, the body also defining a blind cylindrical housing which has a main axis and which is open at its front face, the housing comprising a wall from which there project radially a set of internal lugs capable of forming an internal bayonet connection, the container door also comprising a plate mounted so as to rotate about the main axis relative to the body, the plate comprising, projecting radially from its periphery, a set of external lugs capable of forming an external bayonet connection, the container door being equipped with a device for coupling in rotation to the plate which is accessible from the front face.

### CROSS REFERENCE TO RELATED APPLICATIONS

The present application is a U.S. National Phase of International Application No. PCT/EP2024/051669 entitled “CONTAINER DOOR FOR SEALED TRANSFER SYSTEM”, and filed on Jan. 24, 2024. International Application No. PCT/EP2024/051669 claims priority to French Patent Application No. FR2300669 filed on Jan. 25, 2023. The entire contents of each of the above-listed applications are hereby incorporated by reference for all purposes.

### TECHNICAL FIELD

The invention relates to the tight transfer of objects from a tight container to a cell, with a double-door connection system.

### PRIOR ART

In various industrial sectors, tasks are performed in a confined atmosphere, to protect the environment for example from radioactivity or toxicity, or to perform these tasks in an aseptic atmosphere.

The transfer of objects from a container to a cell, without breaking the tightness, is carried out with a double-door connection device, known for example from documents FR2695343 and US8950624.

Such a device can be used for packaging medicinal products: a filling line is then installed in the cell, and small-sized objects such as vial caps are transferred into the cell to supply this line.

The cell is equipped with a flange which is sealed from the inside by a cell door mounted on a hinge equipping this flange, and the container is for example a bag wherein the opening is provided with another flange equipped with a container door.

The container door conventionally comprises a cylindrical body of main axis provided with a central cylindrical recess defined by a circumferential wall. Inner lugs project radially inwards to form a bayonet connection.

The connection consists of engaging the flange of the container in that of the cell, and in pivoting it on itself, which has the effect of:
connecting the two flanges to each other by engaging a first bayonet connection or flange-flange connection;
connecting the two doors to each other by engaging a second bayonet connection or door-door connection via the inner lugs;
disconnecting the door of the container from the flange thereof by disengaging a third bayonet connection or flange-door connection.

After connection, the cell door is pivoted inwards to open it: the door of the container then being rigidly connected to that of the cell by the door-door connection, it is carried with the cell door to remove it from the container flange.

When the objects have been transferred, the cell door can then be folded back against this opening with the container door borne thereby.

The container is then pivoted on itself in the opposite direction, which has the effect of:
securing the container door to the container flange;
disconnecting the container door from the cell door;
disconnecting the container door from the cell flange.

In such a device, pivoting the container with the flange thereof in relation to the cell flange, to couple them to each other and to uncouple them, requires the operator to exert substantial force. Indeed, this operation necessitates pivoting the container over a substantial angular range against the friction and actuation forces of the different bayonet connections and the respective seals thereof. Such forces exerted repetitively can tire operators, which poses the risk of repetitive strain injury.

The aim of the invention is that of providing a solution to remedy this drawback.

### DISCLOSURE OF THE INVENTION

To this end, a container door is provided comprising a cylindrical body along a main axis of revolution, the body also defining a blind cylindrical recess of main axis and which is open at the front face thereof, the recess comprising a wall with a radially projecting set of inner lugs capable of forming an inner bayonet connection. According to the invention, the door also comprising a plate rotatably mounted about the main axis relative to the body, the plate comprising projecting radially from the periphery thereof a set of outer lugs capable of forming an outer bayonet connection, the door being equipped with a device for rotatably coupling with the plate which is accessible from the front face.

According to specific, non-exclusive and optional embodiments of the invention:
the coupling device comprises an impression intended to cooperate with a homologous profile for transmitting a rotation torque about the main axis.
the impression comprises a quadrilateral pattern;
the door comprises a device for locking the plate against rotation about the main axis relative to the cylindrical body;
the locking device comprises a pin slidably mounted in a recess of the cylindrical body and an end of which is staged and engaged in a port of the coupling device;
the coupling device comprises at least one stop extending in a groove delimited at least partially by a bottom of the recess, the wall of the recess and at least one inner lug of the set of inner lugs;
the coupling device comprises four stops extending in the groove and which are rigidly connected to an arm extending diametrically in the recess;
the door comprises means for returning the plate to the body;
the return means comprise an elastic element;
the outer lugs comprise means for locking the outer bayonet connection;
the locking means comprise axially recessed notches and/or axially projecting protrusions.
the body comprises a device for locking the body against rotation about the main axis;
the locking device comprises a tab projecting radially from the body;

The invention also relates to a cell door arranged to cooperate with the device for rotatably coupling a door as described above.

Further features and advantages of the invention will become apparent on reading the following description of a specific non-limiting embodiment of the invention.

### BRIEF DESCRIPTION OF THE DRAWINGS

The invention will be better understood on reading the following description, given by way of non-limiting example, and made with reference to the figures which represent:

FIG. 1 is a schematic inside view of a cell provided with a cell flange, the door of which is shown closed and which is intended to be connected to a container flange provided with a door according to the invention;

FIG. 2 is a schematic perspective view of the cell of FIG. 1, the door of which is shown open;

FIG. 3 is an exploded perspective view of a container flange equipped with a container door according to a first embodiment of the invention;

FIG. 4 is a sectional view of the flange and the container door of FIG. 3;

FIG. 5 is a perspective view of a first step of connecting a container flange equipped with a door according to the invention to a cell flange;

FIG. 6 is a perspective view of a second step of connecting a container flange equipped with a door according to the invention to a cell flange;

FIG. 7 is a perspective view of a third step of connecting a container flange equipped with a door according to the invention to a cell flange.

FIG. 8 is a sectional view of a container flange equipped with a container door according to a second embodiment of the invention;

FIG. 9 is an exploded perspective view of the flange and the container door of FIG. 8:

FIG. 10 is a perspective view of the container door mounted on the container door of FIG. 8;

FIG. 11 is a schematic perspective view of a container door according to a third embodiment of the invention;

FIG. 12 is a schematic sectional view of the container door of FIG. 11.

### DETAILED DISCLOSURE OF THE INVENTION

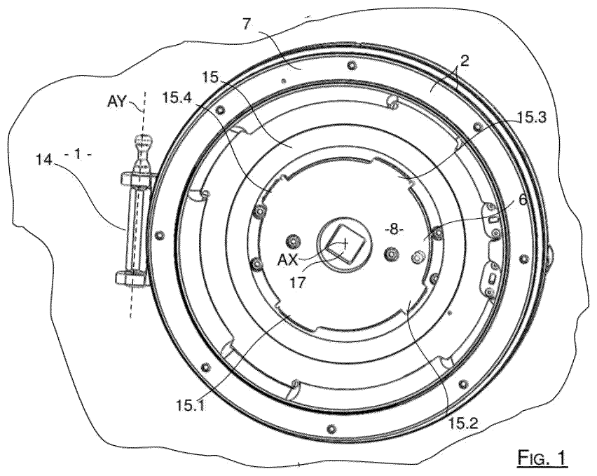

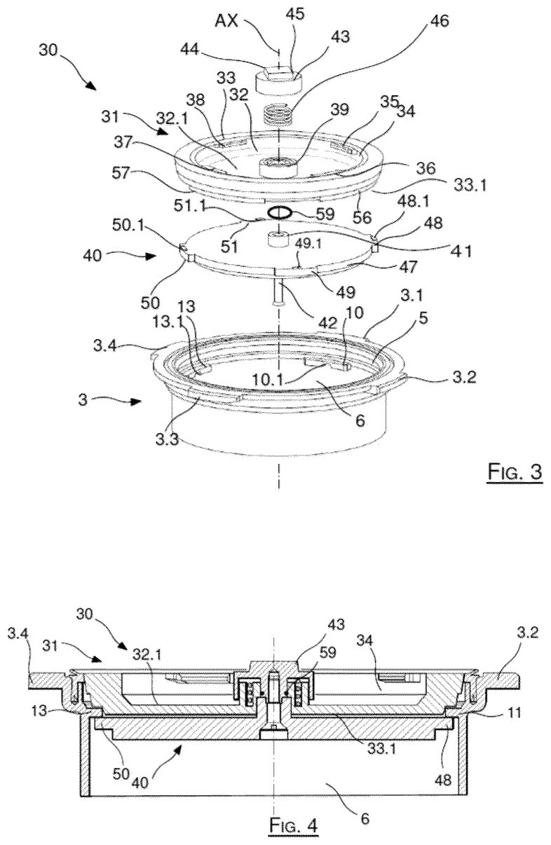

With reference to FIGS. 1 to 3, a cell partition 1 is equipped with a cell flange 2 wherein a container flange 3 provided with a container door 30 is engaged using a first bayonet connection defined by a first set of four cell flange lugs 2 not shown and a first set of four container flange 3 lugs 3.1 to 3.4 seen in FIG. 3. The container per se, not shown, extends from the flange 3, out of the cell, given that it can consist of a flexible bag or a rigid housing.

This cell flange 2 has an inner face 4 facing the inside of the cell which it equips, and an outer face 7 facing the outside of the cell which it equips and to which the container flange 3 is coupled.

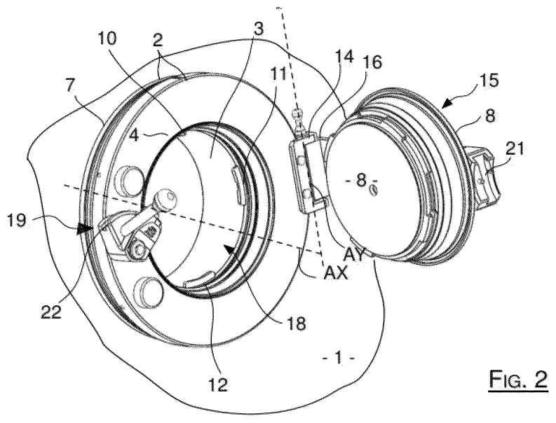

The cell flange 2 is provided on the inside of the cell with a hinge 14 whereon a cell door 15 seen in FIGS. 1 and 2 is mounted. The cell door 15 has an outer face 8 facing the outside of the cell 2. The door 15 per se is connected to the hinge 14 via an arm 16 having an end rigidly connected to the rotary element of the hinge 14 and a body attached to the door 15. The door 15 comprises a locking unit equipped with a cam 21, or engorger, which projects radially from the side opposite to the hinge 14. The door 15 also comprises a first square parallelepipedal impression 17 which is recessed from the face 8 of the door 15. The door 15 comprises four cell door 15 outer tabs 15.1 to 15.4 which project radially from the door 15 towards to the main axis AX.

The cell door 15 opens towards the inside of the cell to release the central opening 18 of the flange 2, as in the configuration of FIG. 2. This door 15 can also occupy a position folded back onto the opening 18 to close it, which corresponds to the configuration of FIG. 1. As seen in FIGS. 1 and 2, the hinge 14 extends along an axis AY which is parallel with the partition 1 and which is here vertically oriented.

The cell flange 2 is equipped with a locking device comprising a rotary lock 19 for selectively cooperating with the cam 21.

The rotary lock 19 is located opposite the hinge 14, and it projects from the inner face 4 while being capable of pivoting about an axis parallel with the axis AX, this lock 19 including a finger 22 extending parallel with the face 4 and which is capable of cooperating with the cam 21.

When the door 15 is folded back, the cam 21 is located facing the lock 19, such that a pivoting of the lock 19 about its axis makes it possible to engage the finger 22 thereof in this cam 21, so as to lock the door. Rotating the lock 19 in the opposite direction makes it possible to disengage its finger 22, to release the cam 21 and enable an opening of the door 15 and the release of the opening 18.

As seen in FIG. 3, the container flange 3 is of annular shape and comprises a cylindrical inner face 5 which defines an inner passage 6. The inner passage 6 includes four inner tabs 10 to 13 regularly distributed about a central main axis AX of the flange 3 and which project radially towards the axis AX. The inner tabs 10 to 13 extend along angular sectors, centred on the axis AX, of thirty degrees. As seen in FIG. 3, the face of the tab 10 facing the inner passage 6 comprises a truncated pyramid-shaped notch 10.1 which is recessed from said face. The inner tabs 11, 12 and 13 respectively comprise similar notches 11.1, 12.1 and 13.1.

As seen in FIG. 3, the container door 30 comprises a revolving cylindrical body 31 along the axis AX. The body 31 also defines a blind cylindrical recess 32 of axis AX and which is open at the front face 33 of the body 31. The recess 32 is delimited by a bottom 32.1 and by a wall 34 with a radially projecting set of four inner tabs 35, 36, 37 and 38 capable of forming an inner bayonet connection with the outer tabs 15.1 to 15.4 of the cell door 15.

The door 30 also comprises a plate 40 rotatably mounted about the axis AX relative to the body 31 and which extends facing a rear face 33.1 of the body 31 opposite to the front face 33. For this purpose, the plate 40 comprises an axial cylindrical protrusion 41 which is received in a central cylindrical bearing 39 of the body 31. A screw 42, which extends through the protrusion 41 and the bearing 39, rotatably connects the plate 40 and a cap 43 located on the side of the front face 33 of the body 31. The cap 43 is provided at the top thereof with a second square parallelepipedal impression 44 which projects from a top face 45 of the cap 43. The second impression 44 is complementary with the first impression 17. A first helical spring 46 inserted between the body 31 and the cap 43 returns the plate 40 to the body 31. A seal 59 at the bearing 39 ensures the tightness between the body 31 and the plate 40.

The plate 40 comprises projecting radially from the periphery 47 thereof a set of four outer lugs 48, 49, 50 and 51 capable of forming an outer bayonet connection with the inner tabs 10 to 13. As seen in FIG. 3, the face of the lug 48 facing the body 31 comprises a truncated pyramid-shaped dog point 48.1 which projects axially from said face. The lugs 49, 50 and 51 respectively comprise similar dog points 49.1, 50.1 and 51.1.

The body 31 comprises four regularly distributed outer stop tabs 55 to 58 projecting radially from the body 31 about the axis AX. Two of these outer stop tabs 56 and 57 are seen in FIG. 3. The outer stop tabs 55 to 58 project radially from the circular outer perimeter of the body 31 to be able to each be engaged between two adjacent inner tabs 10 to 13 of the flange 3 whereon they bear, as in the configuration of FIG. 4. The stop tabs 55 to 58 thus lock a rotation about the axis AX of the body 31 relative to the container flange 3.

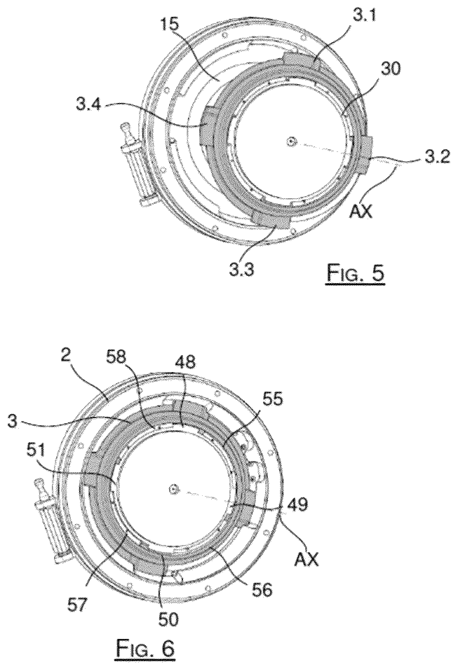

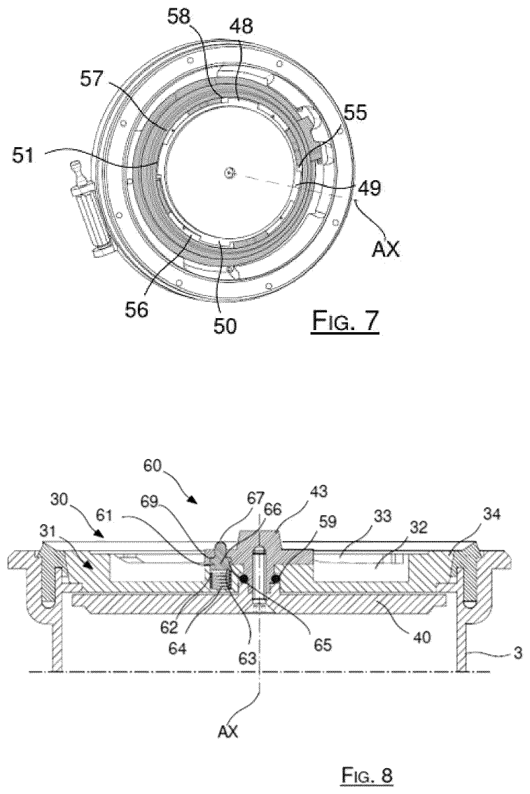

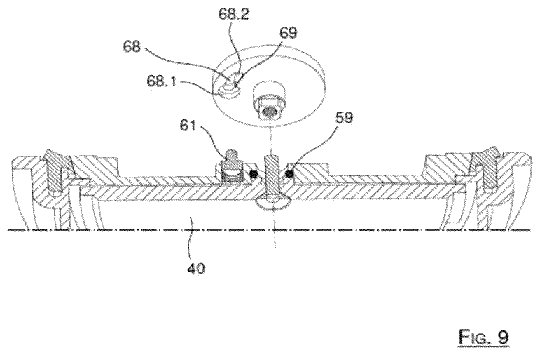

With reference to FIGS. 5 to 7, connecting the container flange 3 to the cell consists of engaging the lugs 3.1 to 3.4 of the container flange 3 in the cell flange 2 (FIGS. 5 and 6), and then pivoting the container flange 3 about the axis AX, for example by means of two gripping handles not shown (FIG. 7). During the operation of approaching the container flange 3 to the cell flange 2 (FIG. 5), the second impression 44 of the cap 43 is received in the first impression 17 of the cell door 15, which rotatably couples the cell door 15 and the plate 40. When the container flange 3 is inserted in the cell flange 2, the bearing force applied by the door 15 on the cap 43 against the first spring 46 induces a translation of the plate 40 relative to the body 31 along a parallel direction with the axis AX. The dog points 48.1, 49.1, 50.1 and 51.1 are respectively removed from the notches 10.1, 11.1, 12.1 and 13.1 and the body 31 is then free to rotate relative to the plate 40 (FIG. 6).

A rotation movement is then applied to the container flange 3 (here a rotation of sixty degrees in the clockwise direction as represented in FIG. 6), and during this rotation movement, the following steps take place:
the first bayonet connection, also referred to as flange-flange connection and not seen in the figures, is engaged to connect the container flange 3 to the cell flange 2 (FIG. 7). This first bayonet connection thus forms a means for coupling the two flanges;
the outer tabs 15.1 to 15.4 of the cell door 15 cooperate with the inner lugs 35 to 38 of the container door 30 to engage the inner bayonet connection, also referred to as door-door connection and not shown in the figures. The inner bayonet connection connects the container door 30 to the cell door 15. This second bayonet connection thus forms a means for connecting and disconnecting the container door and the cell door;
the second impression 44 engaged in the first impression 17 locks a rotation about the axis AX of the plate 40 relative to the cell door 15. The stop tabs 55 to 58 in contact with the inner tabs 10 to 13 lock a rotation about the axis AX of the body 31 relative to the container flange 3. Thus, during the rotation movement of the container flange 3 about the axis AX, the plate 40 remains fixed relative to the cell flange 2 and the body 31 performs a rotation relative to the plate 40 which has the effect of bringing the stop tabs 55 to 58 facing the lugs 48 to 51 and disengaging the outer bayonet connection and disengaging the outer bayonet connection, also referred to as flange-door connection. The container door 30 is then disconnected from the container flange 3.

Once the operation of coupling the container door 30 with the cell door 15 has been completed, opening the cell door 15 makes it possible to free the central opening 18 by carrying the container door 30 therewith, which corresponds to the scenario in FIG. 2.

In the same manner, when the transfer has been carried out, the cell door 15 is folded back before actuating the lock 19 to lock it in the closed state thereof. The operator then pivots the container 3 in the opposite direction, to engage the outer bayonet connection of the plate 40 on the container 3 in order to connect the container door 30 to the container flange 3, disengage the inner bayonet connection in order to disconnect the container door 30 from the cell door 15, and to disengage the connection between the cell flange 2 and the container flange 3 in order to release the latter.

A container is thus obtained, the specific arrangement of the door 30 whereof enables a considerable reduction of the overall force to be applied by an operator to overcome the friction induced by the bayonet connections by drastically reducing the friction induced by the disconnection of the door 30 from the container flange 3.

Identical or similar elements to those described above will bear an identical reference number to that in the following description of a second and a third embodiment of the invention.

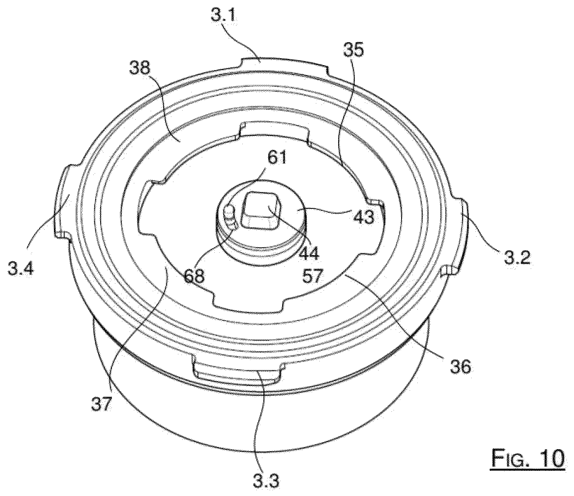

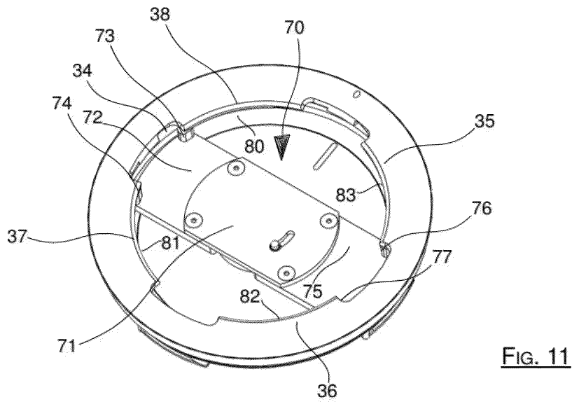

According to a second embodiment of the invention represented in FIGS. 8 and 9, the container door 30 comprises a device 60 for locking the plate 40 against rotation about the main axis (AX) relative to the cylindrical body 31.

The locking device 60 comprises a pin 61 slidably mounted in a recess 62 of the cylindrical body 31. The pin 61 is of cylindrical shape and comprises a lower portion 63, the free end of which is engaged in the recess 62 and whereon a second spring 64 applies a force tending to remove the pin 61 from the recess 62. The upper portion 65 of the pin 61 is staged and comprises a first section 66 of substantially equal to that of the recess 62. The section 66 is topped with a second section 67 of substantially lesser diameter to the diameter of the section 66.

The cap 43 is provided with a port 68 centred on the axis AX and which describes an angular sector of thirty degrees about the axis AX. The slot 68 comprises a first end 68.1 and a second end 68.2. The first end 68.1 comprises a cylindrical impression 69 arranged to accommodate the section 66.

In the absence of a connection with a cell door 15, the pin 61 is pushed back by the spring 64 and the section 66 is engaged in the impression 69. The section 66 engaged in the impression 69 locks a rotation of the plate 40 relative to the body 31 and the container door 3 is locked on the container flange by the outer bayonet connection, also referred to as flange-door connection.

During the operation of approaching the container flange 3 to the cell flange 2, the second impression 44 of the cap 43 is received in the first impression 17 of the cell door 15. The pin 61 is then pushed back by the first impression 17 in the recess 62 against the effect of the spring 64 and the section 66 is pushed back out of the impression 69. The cell door 15 and the plate 40 are then rotatably coupled. A rotation movement is then applied to the container flange 3 (here a rotation of sixty degrees in the clockwise direction as represented in FIG. 9), and during this rotation movement, the following steps take place:
the first bayonet connection, also referred to as flange-flange connection and not seen in the figures, is engaged to connect the container flange 3 to the cell flange 2 via the lugs 3.1 to 3.4. This first bayonet connection thus forms a means for coupling the two flanges;
the outer tabs 15.1 to 15.4 of the cell door 15 cooperate with the inner lugs 35 to 38 of the container door 30 to engage the inner bayonet connection, also referred to as door-door connection and not shown in the figures. The inner bayonet connection connects the container door 30 to the cell door 15. This second bayonet connection thus forms a means for connecting and disconnecting the container door and the cell door;
After a rotation of thirty degrees, the pin 61 comes to a stop on the end 68.2 of the port 68. Thus, when continuing the rotation movement of the container flange 3 about the axis AX, the plate 40 remains fixed relative to the cell flange 2 and the body 31 performs a rotation relative to the plate 40 which has the effect of bringing the stop tabs 55 to 58 facing the lugs 48 to 51 and disengaging the outer bayonet connection and disengaging the outer bayonet connection, also referred to as flange-door connection. The container door 30 is then disconnected from the container flange 3.

Once the operation of coupling the container door 30 with the cell door 15 has been completed, opening the cell door 15 makes it possible to free the central opening 18 by carrying the container door 30 therewith, which corresponds to the scenario in FIG. 2.

In the same manner, when the transfer has been carried out, the cell door 15 is folded back before actuating the lock 19 to lock it in the closed state thereof. The operator then pivots the container 3 in the opposite direction, to engage the outer bayonet connection of the plate 40 on the container 3 in order to connect the container door 30 to the container flange 3, disengage the inner bayonet connection in order to disconnect the container door 30 from the cell door 15, and to disengage the connection between the cell flange 2 and the container flange 3 in order to release the latter.

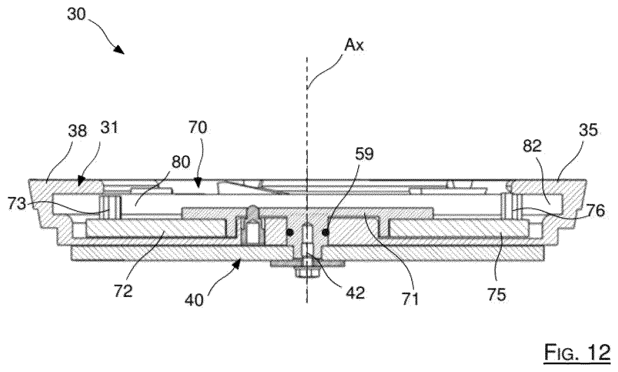

According to a third embodiment of the invention represented in FIGS. 11 and 12, the coupling device 70 comprises a diametral arm 71 rigidly connected with the plate 40 to rotate as one therewith, via the screw 42. The arm 71 comprises a first end 72 from which a first stop 73 and a second stop 74 project axially. The stop 73 extends into a first groove 80 delimited by the bottom 32.1 of the recess 32, the wall 34 and the lug 38. The stop 74 extends into a second groove 81 delimited by the bottom 32.1 of the recess 32, the wall 34 and the lug 37. The arm 71 comprises a second end 75 diametrically opposite the end 72 and from which a third stop 76 and a fourth stop 77 project axially. The stop 76 extends into a third groove 83 delimited by the bottom 32.1 of the recess 32, the wall 34 and the lug 35. The stop 77 extends into a fourth groove 82 delimited by the bottom 32.1 of the recess 32, the wall 34 and the lug 36.

The container door 30 according to this third embodiment is provided to cooperate with a cell 15 wherein the outer face 8 is planar, devoid of impression 17.

In the absence of a connection with the cell door 15, the pin 61 is pushed back by the spring 64 and the section 66 is engaged in the impression 69. The section 66 engaged in the impression 69 locks a rotation of the plate 40 relative to the body 31 and the container door 3 is locked on the container flange by the outer bayonet connection.

When the container flange 3 and the cell flange 2 are engaged, the pin 61 is then pushed back by the outer face 8 of the door 15 in the recess 62 against the effect of the spring 64 and the section 66 is pushed back out of the impression 69.

The outer tab 15.1 of the cell door 15 is engaged between the lugs 37 and 38 and the outer tab 15.3 of the cell door 15 is engaged between the lugs 35 and 36. The outer tab 15.1 is therefore located between the stops 73 and 74, the outer tab 15.3 is located between the stops 76 and 77.

When a rotation movement is applied to the container flange 3 (here a rotation of sixty degrees in the clockwise direction as represented in FIG. 9), the tabs 15.1 and 15.3 respectively bear on the stops 73 and 77 and rotate them respectively in the grooves 80 and 82. Rotating the flange 3 rotates the plate 40, and during this rotation movement, the following steps take place:
the first bayonet connection, also referred to as flange-flange connection and not seen in the figures, is engaged to connect the container flange 3 to the cell flange 2 via the lugs 3.1 to 3.4. This first bayonet connection thus forms a means for coupling the two flanges;
the outer tabs 15.1 to 15.4 of the cell door 15 cooperate with the inner lugs 35 to 38 of the container door 30 to engage the inner bayonet connection, also referred to as door-door connection and not shown in the figures. The inner bayonet connection connects the container door 30 to the cell door 15. This second bayonet connection thus forms a means for connecting and disconnecting the container door and the cell door;
after a rotation of thirty degrees, the pin 61 comes to a stop on the end 68.2 of the port 68. Thus, when continuing the rotation movement of the container flange 3 about the axis AX, the plate 40 remains fixed relative to the cell flange 2 and the body 31 performs a rotation relative to the plate 40 which has the effect of bringing the stop tabs 55 to 58 facing the lugs 48 to 51 and disengaging the outer bayonet connection and disengaging the outer bayonet connection, also referred to as flange-door connection. The container door 30 is then disconnected from the container flange 3.

Once the operation of coupling the container door 30 with the cell door 15 has been completed, opening the cell door 15 makes it possible to free the central opening 18 by carrying the container door 30 therewith, which corresponds to the scenario in FIG. 2.

In the same manner, when the transfer has been carried out, the cell door 15 is folded back before actuating the lock 19 to lock it in the closed state thereof. The operator then pivots the container 3 in the opposite direction and the tabs 15.1 and 15.3 respectively bear on the stops 74 and 76 to drive the plate 40. This makes it possible to engage the outer bayonet connection of the plate 40 on the container 3 in order to connect the container door 30 to the container flange 3, disengage the inner bayonet connection in order to disconnect the container door 30 from the cell door 15, and to disengage the connection between the cell flange 2 and the container flange 3 in order to release the latter.

Of course, the invention is not limited to the embodiments described but encompasses any alternative embodiment falling within the scope of the invention as defined by the claims.

In particular,
although here the impression is a parallelepiped of square cross-section, the invention also applies to other types of impression patterns such as for example other versions of a quadrilateral pattern such as a rectangle, a rhombus or any shape, the impression can also adopt a triangular or polygonal pattern, the impression optionally projecting or being recessed from the top face of the cap;
although here the coupling device comprises a square impression intended to cooperate with an equivalent impression of the container door, the invention also applies to other types of coupling devices accessible from the front face of the door body such as for example a device not requiring modification of the cell door and for which coupling is performed by friction via a friction disk mounted on the cap;
although here the outer lugs comprise truncated pyramid-shaped dog points, the invention also applies to other types of means for locking the outer bayonet connection such as for example cylindrical dog points or any other type of axially projecting protrusions or axially recessed parallelepipedal notches or of any shape;
although here the container comprises a helical spring, the invention also applies to other types of return means which can be elastic type return means such as for example an elastomer block, Belleville washers or a return means devoid of elastic element such as a magnet for example;
although here the outer lugs comprise truncated pyramid-shaped dog points, the invention also applies to other types of means for locking the flange-door (or outer bayonet) connection such as for example cylindrical dog points or any other type of axially projecting protrusions or axially recessed parallelepipedal notches or of any shape;
although here the body comprises four outer stop tabs, the invention also applies to other types for locking the body against rotation, such as for example a single stop tab;
although here the operations for connecting and disconnecting the container and the cell flange require a relative rotation of the container and the cell flange by an amplitude of sixty degrees, the invention also applies to other angular amplitude values such as for example an amplitude of thirty degrees;
although here the diametral arm comprises four stops, the invention also applies an arm comprises a different number of stops such as for example a single stop, two, three or more than four.

1. Container door comprising a cylindrical body along a main axis of revolution, the body also defining a blind cylindrical recess of main axis and which is open at the front face of the body, the recess comprising a wall with a radially projecting set of inner lugs capable of forming an inner bayonet connection, the container door also comprising a plate rotatably mounted about the main axis relative to the body, the plate extending facing a rear face opposite the front face and comprising projecting radially from the periphery thereof a set of outer lugs capable of forming an outer bayonet connection, the container door being equipped with a device for rotatably coupling with the plate which is accessible from the front face.

2. Container door according to claim 1, wherein the coupling device comprises an impression intended to cooperate with a homologous profile for transmitting a rotation torque about the main axis.

3. Container door according to claim 2, wherein the impression comprises a quadrilateral pattern.

4. Container door according to claim 1, comprising a device for locking the plate against rotation about the main axis relative to the cylindrical body.

5. Container door according to claim 4, wherein the locking device comprises a pin slidably mounted in a recess of the cylindrical body and an end of which is staged and engaged in a port of the coupling device.

6. Container door according to claim 4, wherein the coupling device comprises at least one stop extending in a groove delimited at least partially by a bottom of the recess, the wall of the recess and at least one inner lug of the set of inner lugs.

7. Container door according to claim 6, wherein the coupling device comprises four stops extending in the groove and which are rigidly connected to an arm extending diametrically in the recess.

8. Container door according to claim 1, comprising means for returning the plate to the body .

9. Container door according to claim 8, wherein the return means comprise an elastic element.

10. Container door according to claim 8, wherein the outer lugs comprise locking means of the outer bayonet connection.

11. Container door according to claim 10, wherein the locking means comprise axially recessed notches and/or axially projecting protrusions.

12. Container door according to claim 1, wherein the body comprises a device for locking the body against rotation about the main axis and the locking device comprises a tab projecting radially from the body.

13. Cell door arranged to collaborate with a container door according to claim 1 and comprising outer tabs capable of cooperating with the set of inner lugs to form the inner bayonet connection and connecting means for connecting with the rotatable-coupling device
